(19) United States
(12) Patent Application Publication
(10) Pub. No.: US 2014/0269199 A1
(43) Pub. Date: Sep. 18, 2014

(54) SYSTEM AND METHOD FOR DETECTING AND RESPONDING TO INDOOR SHOOTERS

(71) Applicant: SUPERVENE LLC, Liverpool, NY (US)

(72) Inventors: Mark Weldon, Liverpool, NY (US); Adam Lilien, Syracuse, NY (US)

(73) Assignee: Supervene LLC, Liverpool, NY (US)

(21) Appl. No.: 13/804,562

(22) Filed: Mar. 14, 2013

(51) Int. Cl. G01S 3/80

(52) U.S. Cl. CPC G01S 3/8006
USPC 367/124

(57) ABSTRACT

A gunshot detection system having one or more sensors detecting indoor shootings and reporting gunshot detection to a central monitoring system. Each sensor includes a microphone and comparison circuit for processing detected sounds and determining whether the sound is indicative of gunshot. If a gunshot is detected, the sensor reports the detection to nearby sensors and to the central system. The central system can interface with third party systems, such as law enforcement communication systems, to provide particularized information to assist first responding in dealing appropriately with situation.

### BACKGROUND OF THE INVENTION

1. Field of the Invention

The present invention relates to an integrated and robust acoustic, video and actuator network for indoor spaces for the detection of and response to emergencies and, more particularly, to a system and method for the detection of gunshots that provides secure communication of appropriate alerts and spatial-temporal information to potential victims and public safety officials and that activates situation-appropriate countermeasures.

2. Description of the Related Art

Conventional gunshot detection systems are known for determining the source of a weapon discharge through various methods of multi-sensor acoustic triangulation. The context for such systems is predominantly outdoors, and the purpose of such systems is predominantly to provide information for aiming counter-fire. There systems require a plurality of sensors (e.g., three and, preferably, five sensors) and use complex algorithms in order to compensate for the complexity of acoustic interpretation of outdoor sounds. Unless the outdoor acoustic networks are pre-installed in fixed and known locations, however, it is typically necessary for these systems to provide precise GPS information for each sensor in order to triangulate with accuracy. These systems are not useful inside building and other closed environment, such as schools, office buildings, and university campuses.

Public safety officials who first respond to reports of weapons discharges in schools, office buildings and the like often have very little reliable information with which to focus their rescue and interdiction efforts and therefore must engage in fruitless actions that waste valuable time. This may endanger the first responders and certainly prolongs the exposure the shooters have to potential victims. Thus, there is a need for a system that can provide secure (advantageously encrypted), actionable and ongoing information to first responders even as early as while traveling to the emergency site would accelerate and enhance decision-making and deployment. Examples of such useful information include, without limitation, how many shots have been fired so far, the timing and confined space location of each shot detected (advantageously super-imposed on a floorplan of the affected spaces), peripheral information gathered from adjacent spaces (advantageously the presence of people via motion or infrared detectors or video cameras), a real-time stream of acoustic information from affected spaces and advantageously a real-time video stream.

### BRIEF SUMMARY OF THE INVENTION

It is therefore a principal object and advantage of the present invention to provide a system that can detect and respond to shots fired by unauthorized shooters who are inside enclosed spaces, i.e., indoors, including, without limitation, in a building, in a ship, inside an offshore oil rig, on a train, in passages such as tunnels or in other constructed spaces.

Another object of the invention is able to discern, among shots fired by unauthorized indoor shooters, whether the target of those shots is within the same enclosed space as the shooter or in a communicating enclosed space or, from an enclosed space to the outdoors.

An additional object of the invention is to provide a system that can track and respond to movements of unauthorized indoor shooters among enclosed spaces.

A further object of the invention is provide a system that can count the shots fired.

A further object of the invention is to provide a system that can record associated temporal, spatial, acoustical and video information commencing upon the first shot fired and adjusting as needed with each subsequent shot fired, even in varying locations, in a format which can remotely be displayed and replayed by first responders and law enforcement officials.

A further object of the invention is to provide a system that can detect shots by reference to a classification means by which acoustic characteristics unique to gunshots are detected.

A further object of the invention is to provide a system that can discern proximate acoustic signals from extraneous acoustical signals such as reverberations using means selected from a group comprising amplitude comparisons with precise time stamp comparison for nearby sensors to eliminate redundancies, acoustic signal profile comparisons (i.e. the ‘attack’ portion of the acoustic profile versus the exponentially-reduced reverberation portion), and reference to pre-calibrated reverberation models for the site.

A further object of the invention is to provide a system that is unobtrusive to indoor shooters and thus less likely to be defeated by tampering or destruction.

A further object of the invention is to provide a system that can be fully operable despite interruption of usual power sources in the enclosed space.

A further object of the invention is to provide a system that can communicate through wired and wireless networks as may be advantageous to operate in alternative regimes of severed wires or jammed wireless signals.

A further object of the invention is to provide a system that can utilize frequency-hopping in its wireless mode to defeat single-frequency jamming attempts. Such frequency-hopping may comprise conventional frequencies for wi-fi, cellular, cordless phones, etc. or may comprise non-standard frequencies which would be much more difficult to anticipate and jam.

A further object of the invention is to provide a system that can communicate selectably through a hub-and-spoke topology wherein sensors communicate with a central node or a mesh topology wherein sensors relay messages to successive sensors in the mesh until messages arrive at distributed nodes.

A further object of the invention is to provide a system that can send encrypted signals within its communication topologies and beyond the network to remote and nearby law enforcement officials and other authorized receivers, such that unauthorized reading of messages is impracticable.

A further object of the invention is to provide a system that can permit law enforcement officials and other authorized personnel means of communication and control by which they can query the invention for current or past information and selectably activate or deactivate specific elements of the invention.

A further object of the invention is to provide a system that can activate additional sensing and surveillance resources at appropriate times as may selectably be advantageous in various scenarios without overwhelming first-responders with data streams. Such additional resources include, without limitation but by way of example, continuously running audio and video streams in spaces where one or more gunshots were detected, in nearby passageways, in spaces where presence sensors detect occupants, etc.

A further object of the invention is to provide a system that can activate, either autonomously or by intervention of authorized personnel, means by which the mobility or capacity of located shooters may be reduced, such means comprising door locks, blinding lights, darkness, non-lethal weapons, etc.

A further object of the invention is to provide a system that can improve the discrimination between a proximate shot and its acoustic reverberations in a highly reflective acoustical environment by a method comprising the calibration of the invention during initial installation using a well-organized set of realistic but synthetic acoustic trials that creates a customized reverberation model for the site to be referenced in future events. Such acoustic models are then stored in the invention and compared on demand with real acoustic events in order to identify more precisely the spatial and temporal characteristics of such real acoustic events. It may be advantageous periodically to repeat the acoustic trials on site to update the reference reverberation models to control for environmental or structural modifications which may affect the fidelity of earlier models.

A further object of the invention is to provide a system that can detect virtually any non-normal acoustic events of interest to safety or law enforcement personnel, such acoustic events comprising glass-breaking, screams, explosions, etc.

A further object of the invention is to provide a system that has a configurable interface with existing building control systems, including without limitation access systems and lighting systems, both at points of connection in each enclosed space to be monitored and also at one or more control hubs as appropriate.

A further object of the invention is to provide a system that can have a configurable interface with one or more mass notification systems, selectively providing various stakeholders with information of a type and security level as was pre-selected to be useful without compromising law enforcement control of the situation or inadvertently providing assistance to the shooters and accomplices.

In accordance with the foregoing objects and advantages, the present invention provides a networked set of sensors, where each sensor includes a microphone for sensing the sounds associated with a potential gunshot and circuitry for determining whether the sounds were, in fact, produced by the firing of a weapon. Each sensor may then report the detection, using wireless and wired network, to nearby sensors and to a central server that is interconnected to third party systems, such as law enforcement communication systems. In this manner, a detected gunshot can be quickly identified and reported to all authorities, and the information about the specific location provided to first responders. The present invention is particularly useful for the indoor acoustic environments typically found in schools, office buildings, municipal buildings, ships, tunnels or similar constructed spaces. These locations may be complex but otherwise provide for substantial focusing of the source noise within a given space. The resulting acoustic amplitude, when detected by a sensor installed in the same confined space, provides substantially reliable spatial information without the need for complex multi-sensor algorithms and GPS systems. Ambiguities resulting from reverberations in adjacent spaces can be resolved with simple comparisons of acoustic time-of-flight delays and amplitudes.

Because the purpose of detecting weapons discharges in typical indoor spaces is not to aim accurate counter-fire but rather to alert law enforcement officials and potential victims of a localized danger, very useful information may be obtained with a simplified and robust sensor system.

The present invention thus provides a networked set of video cameras co-located with the microphones, which video cameras are activated by the invention in the space where the gunshot is detected as well as in other relevant spaces based on proximity to the detected gunshot, passages for ingress or egress, or where occupancy sensors indicate occupants.

Further, indoor spaces may be equipped with access control systems and other security devices and sensors which may advantageously communicate with the acoustic and video network and may be configured to actuate complementary functions and even countermeasures, for example but without limitation, automatically locking and unlocking doors or activating cameras or other sensors as appropriate.

The present invention selectably activates its designated sensors, including microphones and videocameras, for continuous streaming of time-stamped information from the moment of gunshot detection until the invention is deactivated by authorized law enforcement personnel. These time-stamped data streams are transmitted in selectable formats in real time to designated law enforcement personnel and others and simultaneously stored on digital storage devices incorporated in the invention for replay on remote devices during and after interdiction. Thus, those public safety officials who first respond to reports of weapons discharges in schools, office buildings and the like will have reliable information with which to focus their rescue and interdiction efforts. For example, the system of the present invention can provide secure (advantageously encrypted), actionable and ongoing information to first responders' mobile devices even as early as while traveling to the emergency site would accelerate and enhance decision-making and deployment. The information provided by the system of the present invention may include, without limitation, how many shots have been fired so far, the timing and confined space location of each shot detected (advantageously super-imposed on a floor plan of the affected spaces), peripheral information gathered from adjacent spaces (advantageously the presence of people via motion or infrared detectors), a real-time stream of acoustic information from affected spaces and advantageously a real-time video stream.

Prior to the arrival of law enforcement officials but commencing immediately upon detection, the invention activates additional embodied devices which aid certain building occupants in spaces apart from the detected gunshot. The additional embodied devices comprise graphic or video projectors installed discretely in advantageous locations which project onto floors, walls or ceilings easy to understand graphics and text instructions that direct building occupants to egress along certain paths or alternatively to hide in certain spaces, based on situational assessments made by the invention or according to manual direction by en-route law enforcement officials interacting with the invention via mobile devices. These projected directions would not be activated in the space where a gunshot was detected nor in spaces within possible view of the shooter. Activated video cameras containing the shooter and spaces with motion-detected occupants would allow en-route law enforcement officials to actuate or stop these projections if or as the shooter is moving, to prevent directing the shooter to egressing occupants.

Once law enforcement officials arrive and are physically on the affected premises, the law enforcement officials may activate the invention to create a visual command center in the foyer or other advantageous and predetermined space. The invention may utilize an embodied video projector system, advantageously embedded in the wall or ceiling of the predetermined space, to project on a floor, wall or ceiling one or more selectable real-time video stream(s) from the space(s) of interest in the building or other event information collected by the invention.

Additional functionality provided to the law enforcement officials in directing their interdiction is provided by an embodied network of RFID sensors advantageously placed in enclosed spaces and passageways. These RFID sensors detect the presence and position of special purpose RFID-enabled badges carried by intervening law enforcement officials, including without limitation, SWAT team members. The invention indicates on the visual command center display the real-time locations of detected law enforcement officials on the building floor plans, allowing the interdiction supervisor remotely to assess and direct their movements.

### BRIEF DESCRIPTION OF THE SEVERAL VIEWS OF THE DRAWING(S)

The present invention will be more fully understood and appreciated by reading the following Detailed Description in conjunction with the accompanying drawings, in which:

FIG. 1 is a schematic of a sensor for use in a network for detecting gunshots in a protected location or environment according to the present invention;

FIG. 2 is a schematic of a network of sensors for detecting gunshots in a protected location or environment and interfacing with third party participants according to the present invention.

FIG. 3 is flowchart of a method of detecting gunshots according to the present invention.

### DETAILED DESCRIPTION OF THE INVENTION

Referring now to the drawings, wherein like reference numerals refer to like parts throughout, there is seen in FIG. 1, a schematic of a remote sensor 10 for use in connection with a system for detecting and responding to indoor shootings. Sensor 10 comprises a housing 12 enclosing an acoustic-to-electric transducer 14, such as a microphone, that can create electrical signals from acoustic inputs. Housing 12 is preferably unobtrusive to shooters or embedded in the wall or ceiling and thus less likely to be defeated by tampering or destruction.

Sensor 10 includes a comparator circuit 16 coupled to transducer 14 for receiving the electrical signal and comparing the signal characteristics with model signals stored in an attached memory circuit 18. Such model signals may become programmed in memory circuit 18 at the time of manufacture, or may later be programmed or updated into memory circuit 18, such as through a network connection 20, or may be created by transducer 14 from acoustic events initiated during a configuration process. Temporal pattern recognition algorithms for detecting gunshots, such those that detect a gunshot based on sound waveforms that are typical of muzzle blasts or the resulting ballistic shock waves from the movement of the projectile through the air, are known in the art and could be employed by the present invention. For example, frequency analysis using the Friedlander model could be employed. Sensors 10 could optionally be programmed to detect, recognize, and report on any number of non-normal acoustic events of interest to safety or law enforcement personnel, for example but without limitation glass-breaking, screams, explosions, etc. using additional acoustic detection algorithms.

Comparator circuit 16 is coupled to communication module 22 and programmed to send an appropriate detection signal thereto if the signal characteristics sufficiently match the characteristics of a stored model signal. Communication module 22 may then send at least one message through network connection 20 and/or through a wireless transceiver 24 to a remote institutional network hub 26. Preferably, wireless transceiver 24 uses an uncommon radio frequency that is unlikely to be jammable by a shooter or accomplice. Preferably, sensor 10 is programmed to encrypt messages using known encryption techniques to prevent unauthorized interception.

Sensor 10 further comprises a power source 28, such as a power connection 30 for connecting to building power, along with power circuitry 32 to control and provide a steady source of power for the operation of sensor 10. Sensor 10 preferably includes a backup power source 34, such as a backup battery, interconnected to power circuitry 32 to ensure that sensor 10 remains active even if the building power supply is interrupted.

In a preferred embodiment, sensor 10 using communications module 22, also sends a message via wireless transceiver 24 to other acoustic sensors 10 installed within wireless range. Such adjacent sensors 10 receive and process the messages with their corresponding wireless transceiver 24 and communications modules 22, and then retransmit the message to other adjacent sensors 10 within range. As long as every acoustic sensing module is installed within wireless range of at least one other acoustic sensing module, this retransmission mesh topology quickly alerts all acoustic sensing modules in an entire building or structure.

As seen in FIG. 2, sensor 10 may be part of location supervisory system 36 that includes multiple sensors 10 as well as interconnection to third party systems or participants. For example, sensors 10 may provide a detection message through network connection 20 to a network hub 26, and the message may then be retransmitted by network hub 26 throughout location supervisory system 36. Location supervisory system 36 may further include a building control system 38, a mass notification system 40, and a surveillance assets system 42 coupled to the network hub 26. Supervisory system 36 may further include an event recorder 44 for providing real-time and archival recording of system events. Supervisory system 36 may further report events to third parties, such as law enforcement and stakeholders (such as building owners, campus officials, etc.) using a mass notification system 40 according to any desired protocol. It should be recognized by those of skill in the art that various components, such as the surveillance assets system 42, may also report directly to or be capable of being accessed directly by appropriate persons, such as law enforcement.

Sensors 10 further comprises an external sensor bus 46 for allowing other types of sensors 48 to be interconnected to sensor 10 using an appropriate communication protocol. Alternatively, or in addition thereto, external sensors 48 may communicate wirelessly with wireless transceiver 24 of sensor 10. Useful external sensors 48 may include, without limitation, infrared presence and temperature sensors, cameras or other light sensors, laser scanners, sonars, radars, additional microphones or other vibration sensors, smoke detectors, olfactometers, and other chemical sensors. Such external sensors 48 may be held in a dormant mode until activated by commands from the acoustic sensing module and then, upon activation, the signals collected from such external sensors may also processed by communication module 22 of sensor 10 and passed along accordingly. Thus, sensor 10 may be capable of providing a host of useful information on its own or in combination with external components. For example, sensor 10 may determine and report on how many shots have been fired in a given time period, the timing and space location of each shot detected (advantageously super-imposed on a floor plan of the affected spaces on a display associated with supervisory system 36), peripheral information gathered from adjacent spaces (advantageously the presence of people via motion or infrared detectors), a real-time stream of acoustic information from affected spaces and advantageously a real-time video stream (provided by external video or on-board cameras).

Sensor 10 may also contains a radio-frequency jammer module 50 that, upon activation by at least one command issued by comparator 16, emits a localized jamming signal on at least one frequency, such frequency comprising common cell phone frequencies, civilian walkie-talkie frequencies, cordless phone frequencies, CB radio, police scanner and WiFi frequencies. The purpose of this localized jamming is to prevent a perpetrator from communicating with an accomplice through typical means and to prevent a perpetrator from eavesdropping on police frequencies. Law enforcement frequencies outside the limited jamming radius would be unaffected. The one or more wireless frequencies used by the invention and external sensors and systems would be selected to be unaffected by the jamming frequencies. Preferably, sensor 10 employs frequency-hopping in its wireless mode to defeat single-frequency jamming attempts. Such frequency-hopping may comprise conventional frequencies for wi-fi, cellular, cordless phones, etc. or may comprise non-standard frequencies which would be much more difficult to anticipate and jam.

Sensor 10 preferably has redundant means by which all its functions may be periodically tested. One means is by manual or automatic remote polling from the network hub 26, wirelessly and/or through the wired network, to selectively initiate testing procedures to evaluate detection and communication performance. Yet another means for testing is a wireless equivalent, embodied in a handheld unit that communicates with wireless transceiver 24 of sensor 10 and can initiate and control one or more testing modes established in sensor 10 during manufacture or later updates.

To calibrate the invention during installation and commissioning to account for the reverberation characteristics of its particular acoustical environment, it may be advantageous to create acoustic models for storage in memory 18 from on site acoustic events, rather than factory settings, to more closely store for future analysis the particular acoustical characteristics of a particular location. To do this, sensor 10 may include a recording mode that can detect an acoustic event created on site using transducer 14 and then save the resulting signal characteristics in memory 18 as a model signal for future evaluation against actual events. For example, sensor 10 could be configured on site with multiple acoustic models with multiple acoustic events of the same kind but with varying proximity and reverberation paths. This process could be repeated periodically to update acoustic models for any structural changes to the acoustic environment.

It should be recognized by those of skill in the art that nearly all of the modules of sensor 10 and its associated component may be implemented in software, firmware, hardware, or a combination thereof. For example, sensor 10 may include a single microcontroller that is programmed to implement the functionality of various modules, such as comparator circuit 16 and communication module 22, as well as the testing, configuration, and on site memory functions discussed above.

Supervisory system 36 can comprise a server-based arrangement supporting sensors 10 as well as one or more back-office style terminals 52 for displaying the status of sensors 10 and any events detected by sensors 10 in a useful manner. For example, terminal 52 could superimpose status information on a location diagram or campus map that provides information about the location along with sensor 10 information, with similar views available to third parties having appropriate access privileges. System 36 can also provide a count of the shots fired while recording associated temporal, spatial and acoustical information with each shot in a useful format for first responders and law enforcement officials. Sensors 10 or system 36 can be programmed to provide spatial information about shots fired by reference to a classification means by which acoustic characteristics unique to gunshots are detected, as well as numeric information about shots fired with means by which extraneous acoustical signals are discounted, such as amplitude comparisons with precise time stamp comparison for nearby sensors to eliminate redundancies, acoustic signal profile comparisons (i.e., the ‘attack’ portion of the acoustic profile versus the exponentially-reduced reverberation portion), and reference to pre-calibrated reverberation models for the site. Sensors 10 may also be programmed to provide a real-time feed of any on-board or external detectors when requested by an authorized party. For example, law enforcement could trigger sensors 10 to provide acoustic and/or video feeds, such as that provided by external sensors 48. In addition, system 36 could be programmed to allow law enforcement easy access to and control over building lighting, door locks, etc. by virtue of the interconnection to building control system 38. In this manner, system 36 may be provided as part of a larger, enterprise building control system or as an accompanying package.

What is claimed is:

1. A system for the detection of gunshots fired indoors, comprising:
a transducer for receiving a target sound and converting said sound into a target signal;
a database comprising data representative of at least one acoustic characteristic associated with an indoor event;
a comparator in communication with said transducer and said database, wherein said comparator is programmed to compare said target signal with said data and to output a detection signal if said target sound corresponds to said data;
a communication module in communication with said comparator that is programmed to provide an alert that an indoor shooting event has occurred in response to said detection signal.

2. The system of claim 1, wherein said event is a gunshot.

3. The method of claim 1, wherein said event is selected from the group consisting of a breaking of glass, a human scream, a gunshot, and an explosion.

4. The system of claim 1, further comprising:
a backup power source.

5. The system of claim 1, wherein said detection signal comprises data representing a timestamp and a location.

6. The system of claim 1, wherein said detection signal is encrypted.

7. The system of claim 1, further comprising a wireless transceiver in communication with said communication module.

8. The system of claim 1, further comprising a network connection in communication with said communication module.

9. The system of claim 1, further comprising a radio frequency jammer in communication with said communication module.

10. A network for the detection of gunshots fired indoors, comprising:
a plurality of sensors, wherein each said sensor comprises a transducer for receiving a target sound and converting said sound into a target signal, a database comprising data representative of at least one acoustic characteristic associated with an indoor event, a comparator in communication with said transducer and said database, wherein said comparator is programmed to compare said target signal with said data and to output a detection signal if said target sound corresponds to said data, and a communication module in communication with said comparator that is programmed to provide an alert that an indoor shooting event has occurred in response to said detection signal;
a network hub in communication with the communication module of at least one of said sensors that is programmed to broadcast said alert; and
a mass notification system in communication with said network hub programmed to distribute said alert throughout a predetermined population.

11. The network of claim 10, further comprising:
an event recorder in communication with said network hub and for receiving and storing data from said network hub.

12. The network of claim 11, further comprising:
a terminal for control of said network and to receive information from said network and in communication with said network hub.

13. The network of claim 11, further comprising:
a surveillance assets system in communication with said network hub for reporting said alert to a third party.

14. A method for the detection of gunshots fired indoors, comprising:
providing an electronic device having a transducer, a database containing data representing at least one acoustic signal characteristic of at least one indoor event, and a comparator for comparing signals received from said transducer to said data;
receiving a target audio input having acoustic signal characteristics;
analyzing said target audio input acoustic characteristics to determine whether said target audio input has an acoustic signal characteristic that correspond to said data.
outputting a detection signal if said target audio input acoustic characteristics correspond to said data.

15. The method of claim 14, wherein said event is a gunshot.

16. The method of claim 14, wherein said event is selected from the group consisting of a breaking of glass, a scream, a gunshot, and an explosion.

17. The method of claim 14, wherein said detection signal comprises data representing a location and a timestamp.

18. The method of claim 14, further comprising communicating said detection signal to at least one other electronic device.

19. The method of claim 14, further comprising communicating said detection signal to a third party.

20. The method of claim 14, wherein said third party is law enforcement.

21. The method of claim 14, wherein said detection signal is encrypted.
